(19) United States
(12) Patent Application Publication
(10) Pub. No.: US 2014/0184920 A1
(43) Pub. Date: Jul. 3, 2014

(54) WIRELESS COMMUNICATION DEVICE, DISPLAY APPARATUS, TELEVISION RECEIVER AND METHOD FOR ADJUSTING RESONANCE FREQUENCY

(71) Applicants: Takeshi Ikeda, Osaka-shi (JP); Teruyoshi Monden, Osaka-shi (JP)

(72) Inventors: Takeshi Ikeda, Osaka-shi (JP); Teruyoshi Monden, Osaka-shi (JP)

(73) Assignee: SHARP KABUSHIKI KAISHA, Osaka-shi, Osaka (JP)

(21) Appl. No.: 14/238,066

(22) PCT Filed: Jun. 29, 2012
(86) PCT No.: PCT/JP2012/066698

§ 371 Date: Feb. 10, 2014

(30) Foreign Application Priority Data
Aug. 31, 2011 (JP) 2011-189959
Dec. 22, 2011 (JP) 2011-282141

(51) Int. Cl. H01Q 9/06; H04N 5/44

(52) U.S. Cl. CPC H01Q 9/06; H04N 5/44
USPC 348/725; 343/872; 264/40.1

(57) ABSTRACT

In a wireless communication device having a sheet-like antenna 41 and a first and second covers 42, 43 covering the antenna 41, a dielectric first rib 42a that is in contact with the antenna 41 is provided on the antenna 41 side of the first cover 42. The method for adjusting a resonance frequency is as described below. The first cover 42 on which the first rib 42a is provided is molded using a mold, a resonance frequency of the antenna 41 covered with the first cover 42 thus molded is measured, and the measured resonance frequency is compared with a predetermined frequency. The mold is changed such that the contact area between the first rib 42a and the antenna 41 is increased when the measured resonance frequency is higher than the predetermined frequency, and is decreased when the measured resonance frequency is lower than the predetermined frequency.

### CROSS-REFERENCE TO RELATED APPLICATIONS

This non-provisional application is a National Stage entry under U.S.C. §371 of International Application No. PCT/JP2012/066698 filed on Jun. 29, 2012, which claims the benefit of Japanese Patent Application Nos. 2011-189959 filed in Japan on Aug. 31, 2011 and 2011-282141 filed in Japan on Dec. 22, 2011. The entire contents of all of the above applications are hereby incorporated by reference.

### FIELD

The present invention relates to a wireless communication device, a display apparatus, a television receiver in which a dielectric rib that is in contact with a sheet-like antenna is provided on a cover which covers the antenna, and a method for adjusting a resonance frequency of an antenna provided in each device.

### BACKGROUND

A sheet-like antenna is included in a wireless communication device, such as a television receiver, a portable terminal, a notebook computer, which constitutes a wireless communication system represented by a wireless LAN, Bluetooth (registered trademark), ZigBee, HomeRF, or the like. In order to optimize the sensitivity of transmission and reception of a wireless communication device, the resonance frequency of an electric wave needs to be adjusted to a predetermined frequency which is defined by a standard. However, when adopting a method for adjusting a resonance frequency by changing the pattern shape of an antenna, there is a problem that a great deal of time and cost are needed to change the pattern of an antenna.

Japanese Patent Application Laid-Open No.H8-181530 discloses a method for adjusting a resonance frequency, which does not need to change the pattern of an antenna. The method for adjusting a resonance frequency according to the Japanese Patent Application is to adjust a resonance frequency by grinding a surface of a mold resin structure which covers the entire antenna, or applying a resin or attaching a resin sheet to the surface.

### SUMMARY

However, in the method for adjusting a resonance frequency according to Patent Document 1, a ground part and a radiating element constituting an antenna are entirely embedded in resin. This causes a problem that the antenna part of the wireless communication device is enlarged and becomes heavier.

Also, the method for adjusting a resonance frequency according to Patent Document 1 is a technique that a resonance frequency is adjusted by processing a surface of a mold resin structure. Therefore, there is a problem that it is necessary to process a mold resin structure for each mass-produced wireless communication device, which requires time for adjustment due to cutting associated therewith.

The present invention is made in view of the above circumstances. An object of the invention is to provide a wireless communication device, a display apparatus, a television receiver and a method for adjusting a resonance frequency of an antenna included in each of the devices, which allow reduction in size and weight of a device compared to that in the prior art and also allow easy adjustment of a resonance frequency of a mass produced device.

A wireless communication device according to the present invention comprises a sheet-like antenna and a cover for covering the antenna, wherein a dielectric rib that is in contact with the antenna is provided on the antenna side of the cover.

In the present invention, by changing a contact area of the dielectric rib that is in contact with the sheet-like antenna, it is possible to vary the dielectric constant around the antenna and to adjust the resonance frequency. For example, by cutting a mold for molding a cover on which a rib is formed, it is possible to change the shape of the rib and change the contact area between the antenna and the rib. As the shape of the rib can be changed by cutting the mold, the resonance frequency of each wireless communication device which is mass-produced can easily be adjusted.

Also, because of the structure in which the rib formed on the cover is in contact with the sheet-like antenna, the structure of the antenna part is smaller and lighter compared to the structure in which the entire antenna is embedded in resin. The sheet-like antenna indicates that at least an element of the antenna is mounted in a sheet-like manner, which includes a case where an element of the antenna is print-formed on a rigid substrate.

Moreover, the cover for covering the antenna is usually installed at a position in which the cover is easily seen by a user as it is necessary to enhance the sensitivity of the antenna as much as possible. In the present invention, the structure of the dielectric provided on the cover is in a rib shape. Therefore, as the structure is thin, a sink mark is not generated on a surface of the molded cover, thereby not spoiling the aesthetic appearance of the cover.

The wireless communication device according to the present invention is characterized in that a plurality of the ribs are provided on the cover.

In the present invention, it is possible to increase the dielectric constant around the antenna and decrease the resonance frequency while preventing occurrence of a sink mark on a cover. In other words, it is possible to increase an adjustment range of the resonance frequency of the antenna without spoiling the aesthetic appearance of the cover.

The wireless communication device according to the present invention is characterized in that at least one of the plurality of ribs has a different thickness.

In the present invention, by snapping off at least one of the ribs having different thicknesses in accordance with the amount of adjustment of the resonance frequency of the antenna, it is possible to change the contact area between the antenna and the ribs so as to vary the resonance frequency of the antenna efficiently.

The wireless communication device according to the present invention is characterized in that the plurality of ribs are provided on a plurality of portions of the cover on which the antenna can be arranged, and the plurality of ribs provided in each portion are configured such that, when the antenna is provided in each of the portions, a total area in which the plurality of ribs are in contact with the antenna is different for each portion.

In the present invention, by changing the portion in which the antenna is placed, it is possible to change the contact area between the antenna and the ribs so as to vary the resonance frequency of the antenna efficiently.

The wireless communication device according to the present invention is characterized in that at least one of the plurality of ribs has a different thickness, and the plurality of ribs are provided side by side with one another in an area wider than an area in which the antenna is in contact with the ribs.

In the present invention, by changing the arrangement of the antenna, it is possible to change the contact area between the antenna and the ribs so as to vary the resonance frequency of the antenna efficiently.

The wireless communication device according to the present invention is characterized in that a groove is formed at a connecting part between the rib and the cover.

In the present invention, by removing the rib through snapping off, it is possible to change the contact area between the antenna and the rib so as to vary the resonance frequency of the antenna.

The wireless communication device according to the present invention is characterized in that the antenna includes a ground part and a sheet-like radiating element connected to the ground part, and the rib is in contact with at least the radiating element.

In the present invention, as the ribs are in contact with a radiating element of an antenna, a resonance frequency greatly varies when a contact area between the antenna and the rib is changed, compared to a case where the rib is in contact with the other portions of the antenna.

The wireless communication device according to the present invention is characterized in that the ground part and the radiating element are print-formed on a rigid substrate or a flexible substrate.

In the present invention, it is possible to adjust the resonance frequency of the antenna which is made by print-forming the ground part and the radiating element on a rigid substrate or a flexible substrate.

The wireless communication device according to the present invention is characterized in that the cover includes a first cover for covering one surface side of the antenna and a second cover for covering another surface side of the antenna, wherein the ribs are provided on the first cover and the second cover, respectively, the rib provided on the first cover coming into contact with one surface side of the antenna and the rib provided on the second cover coming into contact with another surface side of the antenna.

In the present invention, as the ribs are in contact with both surfaces of the antenna, the dielectric constant around the antenna is more increased and the resonance frequency is decreased.

The wireless communication device according to the present invention comprises a display unit, wherein the antenna is provided on a periphery of the display unit.

In the present invention, it is possible to adjust the resonance frequency of the antenna in the wireless communication device having the display unit.

A display apparatus according to the present invention comprises a display unit, a sheet-like antenna provided on a periphery of the display unit, and a cover for covering the antenna, wherein a dielectric rib that is in contact with the antenna is provided on the antenna side of the cover.

In the present invention, as similar to the above-mentioned wireless communication device, it is possible to easily adjust the resonance frequency of the antenna in the display apparatus. Also, the structure of the antenna is smaller and lighter. Since no sink mark is generated on the molded cover, the aesthetic appearance of the cover is not spoiled.

A television receiver according to the present invention comprises a receiving part for receiving a television signal, a display unit for displaying an image with a television signal received by the receiving part, a sheet-like antenna provided on a periphery of the display unit, and a cover for covering the antenna, wherein a dielectric rib that is in contact with the antenna is provided on the antenna side of the cover.

In the present invention, as similar to the above-mentioned wireless communication device, it is possible to easily adjust the resonance frequency of the antenna in the television receiver. Also, the structure of the antenna is smaller and lighter. Since no sink mark is generated on the molded cover, the aesthetic appearance of the cover is not spoiled.

A method for adjusting a resonance frequency according to the present invention is the method for adjusting a resonance frequency of the antenna included in the wireless communication device, the display apparatus, or the television receiver characterized by molding, using a mold, a cover on which the rib is provided, measuring a resonance frequency of the antenna covered with the molded cover, comparing the measured resonance frequency with a predetermined frequency, and changing the mold so that a contact area between the rib and the antenna is increased when the measured resonance frequency is higher than the predetermined frequency, and that a contact area between the rib and the antenna is decreased when the measured resonance frequency is lower than the predetermined frequency.

In the present invention, as the resonance frequency of the antenna provided on the wireless communication device, the display apparatus or the television receiver is compared with a predetermined frequency, and then the mold is changed based on the comparison result. Specifically, when the measured resonance frequency is higher than a predetermined frequency, the mold is changed, for example, by cutting a portion of the mold corresponding to the rib, for increasing the contact area between the rib and the antenna. When the contact area between the rib and the antenna is increased, the dielectric constant around the antenna is increased while the resonance frequency is lowered. Similarly, when the measured resonance frequency is lower than the predetermined frequency, the mold is changed so as to decrease the contact area between the rib and the antenna. When the contact area between the rib and the antenna is decreased, the dielectric constant around the antenna is decreased and the resonance frequency becomes higher.

According to the present invention, it is possible to achieve reduction in size and weight of a device compared to that in the prior art, and to easily adjust the resonance frequency of a mass-produced wireless communication device, display apparatus and television receiver.

The above and further objects and features will more fully be apparent from the following detailed description with accompanying drawings.

### BRIEF DESCRIPTION OF THE DRAWINGS

FIG. 1 is a front view illustrating a configuration example of a display apparatus according to an embodiment of the present invention;

FIG. 2 is an exploded perspective view illustrating a wireless communication part when viewed from the rear side;

FIG. 3 is an exploded perspective view illustrating a main part of a wireless communication part when viewed from the rear side;

FIG. 4A is a rear view of a wireless communication part;

FIG. 4B is a cross sectional view of a wireless communication part;

FIG. 5 is a vertical sectional view of a wireless communication part;

FIG. 6A is a rear view of a wireless communication part from which the second cover is removed;

FIG. 6B is a cross sectional view of a wireless communication part from which the second cover is removed;

FIG. 7 is a vertical sectional view of a wireless communication part from which the second cover is removed;

FIG. 8 is a flowchart illustrating a method for adjusting a resonance frequency;

FIG. 9 is an exploded perspective view of a main part of a wireless communication part included in a display apparatus according to Modification 1, when viewed from the rear side;

FIG. 10A is a rear view of a wireless communication part according to Modification 1;

FIG. 10B is a cross sectional view of a wireless communication part according to Modification 1;

FIG. 11 is a vertical sectional view of a wireless communication part according to Modification 1;

FIG. 12A is a rear view of a wireless communication part according to Modification 1 from which the second cover is removed;

FIG. 12B is a cross sectional view of a wireless communication part according to Modification 1 from which the second cover is removed;

FIG. 13 is a vertical sectional view of a wireless communication part according to Modification 1 from which the second cover is removed;

FIG. 14 is an exploded perspective view of a main part of a wireless communication part according to Modification 2, when viewed from the rear side;

FIG. 15 is an exploded perspective view of a main part of a wireless communication part in which some of the first ribs are snapped off for reducing the number of the ribs, when viewed from the rear side;

FIG. 16 is an exploded perspective view of a wireless communication part according to Modification 3 from which the second cover is removed;

FIG. 17 is a vertical sectional view of a wireless communication part according to Modification 4 from which the second cover is removed;

FIG. 18A is a vertical sectional view of a wireless communication part according to Modification 5 from which the second cover is removed;

FIG. 18B is a vertical sectional view of a wireless communication part according to Modification 5 from which the second cover is removed;

FIG. 18C is a vertical sectional view of a wireless communication part according to Modification 5 from which the second cover is removed;

FIG. 19A is a perspective view illustrating a plurality of different second covers according to Modification 6;

FIG. 19B is a perspective view illustrating a plurality of different second covers according to Modification 6;

FIG. 20 is a perspective view illustrating a main part of the second cover having the second rib of an L-shape; and

FIG. 21 is a perspective view illustrating a main part of the second cover having the second rib of a T-shape.

### DETAILED DESCRIPTION OF NON-LIMITING EXAMPLE EMBODIMENTS

The present invention is now be described below with reference to the drawings illustrating an embodiment thereof.

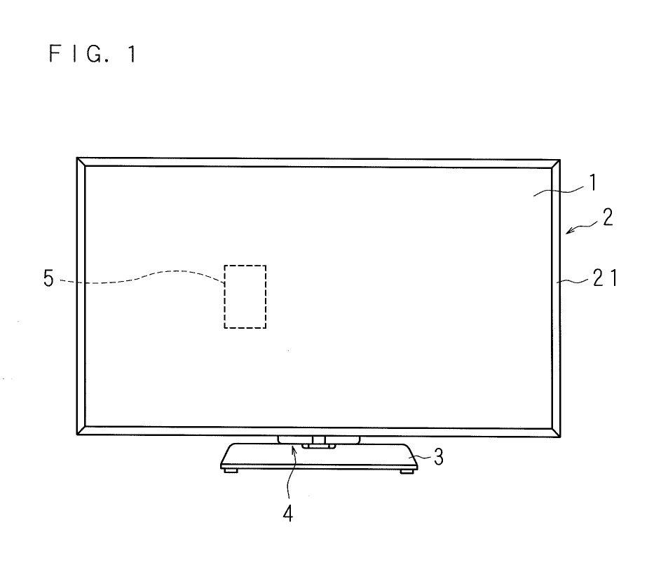

FIG. 1 is a front view illustrating a configuration example of a display apparatus according to an embodiment of the present invention. A display apparatus according to the present embodiment is an example of a wireless communication device having a wireless communication function, such as Wi-Fi, Bluetooth (registered trademark), ZigBee, or the like. Hereinafter, as a specific example of a display apparatus, details are described by referring to a television receiver, such as a liquid crystal television. The display apparatus has a display surface on the front side and includes a display unit 1 formed in the shape of a substantially rectangular parallelepiped, a cabinet 2 surrounding the periphery part and the rear face of the display unit 1, a stand 3 supporting the display unit 1 in the standing position, a wireless communication part 4 fixed to the lower part of the display unit 1, and a tuner (receiving part) 5 receiving a television signal.

The display unit 1 includes a liquid crystal panel in a long sideways and substantially rectangular shape having a display surface on its front side, an optical sheet arranged on the rear face side of the liquid crystal panel, a backlight device arranged on the rear face side of the optical sheet, a holding frame body which holds the liquid crystal panel and the backlight device integrally. The backlight device has a plate-shaped backlight chassis, a reflecting sheet located at the backlight chassis and a plurality of light sources. Each of the light sources is, for example, a LED or a cold-cathode fluorescent tube. Here, a liquid crystal panel module is described as an example of the display unit 1. Needless to say, it is also possible to configure the display unit 1 using a display module such as a plasma display, an OEL display, an electric paper or the like.

A cabinet 2 is configured with a front cabinet 21 surrounding the periphery part of the display unit 1 and a back cabinet covering the rear side of the display unit 1. The front cabinet 21 and the back cabinet are fastened to the display unit 1 while covering the front and rear sides of the display unit 1.

The tuner 5 is attached to the rear side of the backlight chassis which configures the backlight device. The tuner 5 detects a television signal of a channel instructed from a control unit (not illustrated), and performs OFDM demodulation thereon. Image data in MPEG2TS format included in the demodulated signal is decoded by a decoder (not illustrated), and the decoded image data is outputted to the display unit 1. The display unit 1 displays image based on the image data outputted from the decoder. Here, as an example, a case is described in which the tuner 5 is built in. Needless to say, it is also possible to have such a configuration that the tuner 5 is separated from the display apparatus (separated type) and an image signal is transmitted via wireless communication.

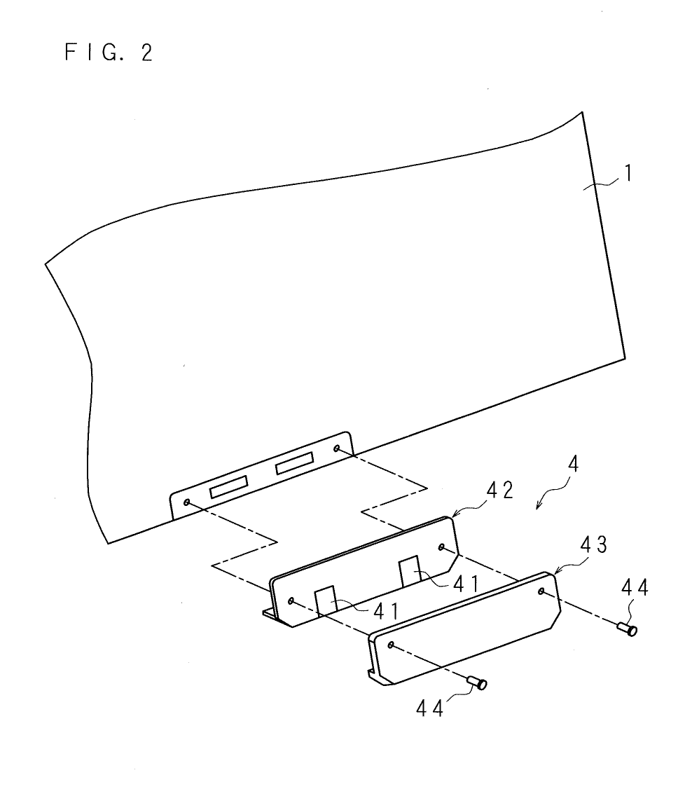

FIG. 2 is an exploded perspective view illustrating the wireless communication part 4 when it is viewed from a rear side. The wireless communication part 4 includes an antenna 41 for performing wireless communication with an external communication device. Although the standard for wireless communication is not limited, IEEE 802.11b standard or IEEE 802.11g standard for performing wireless communication utilizing the 2.4 GHz bandwidth, IEEE 802.11a standard for performing wireless communication utilizing the 5 GHz bandwidth or the like is used. The antenna 41 is covered from the front and rear sides with a first cover 42 covering the front side of the antenna 41 and a second cover 43 covering the rear side of the antenna 41, and fixed to the lower portion of the rear face of the display unit 1 with a screw 44. Although FIG. 2 illustrates a MIMO method in which two antennas 41 are covered with the first and second covers 42, 43 and accommodated, it may also be possible to have such a configuration that a single antenna 41 or three or more antennas 41 are provided. As two antennas 41 have similar configurations, details of the configuration of one of the antennas 41, and the first and second covers 42, 43 covering the antenna 41 are described hereinafter.

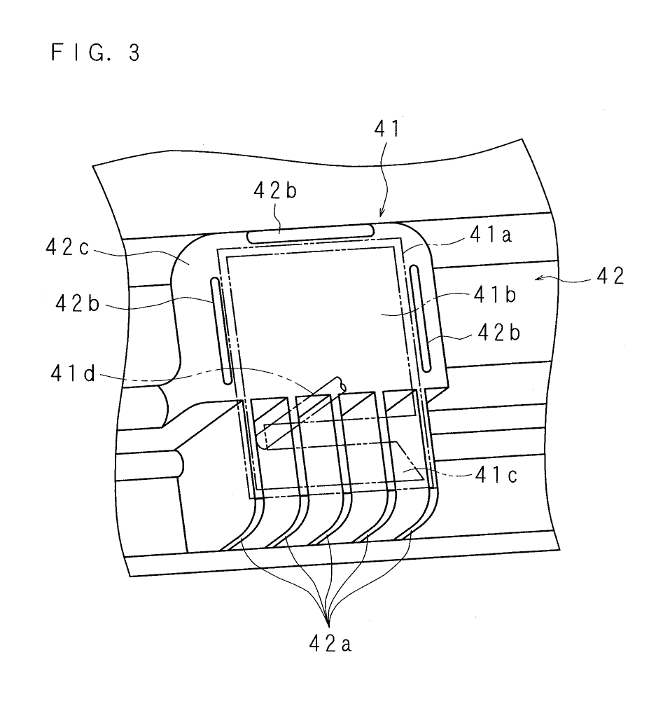

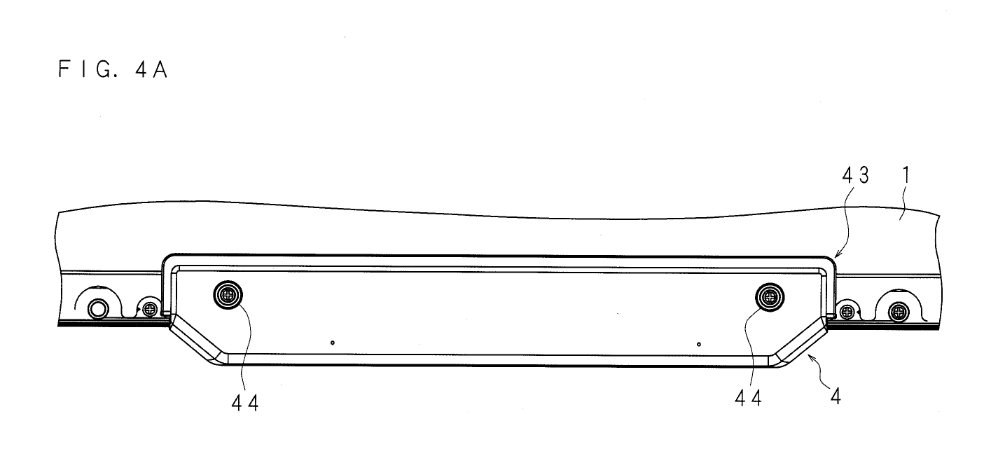

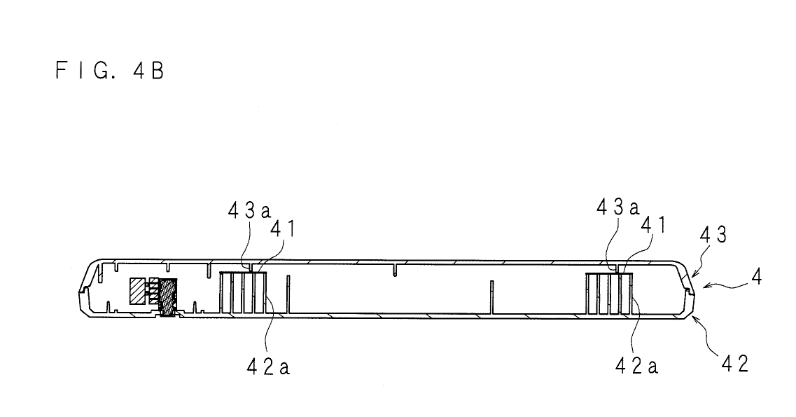

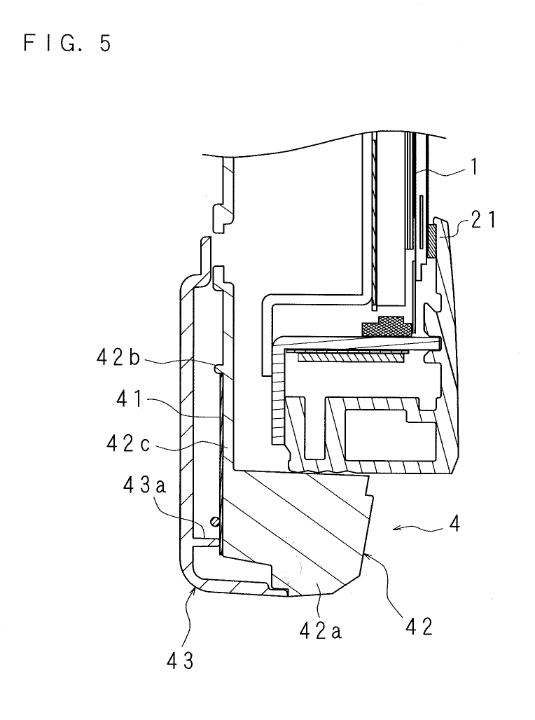

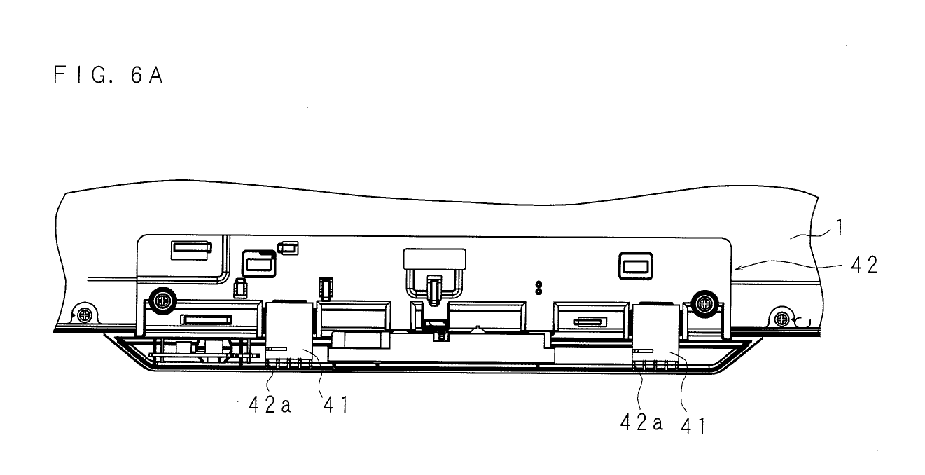

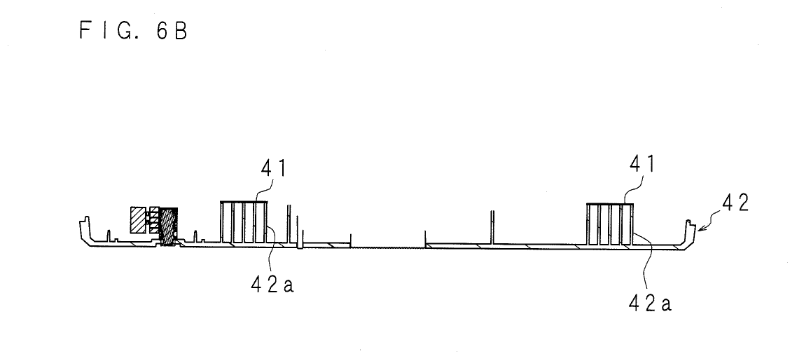

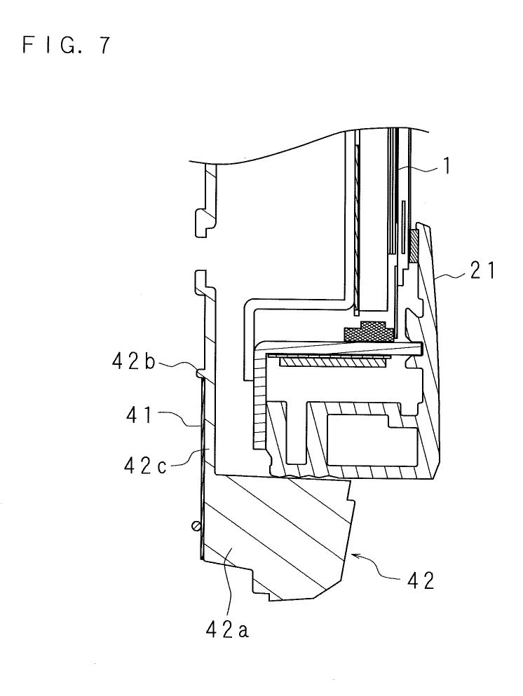

FIG. 3 is an exploded perspective view illustrating a main part of the wireless communication part 4 when viewed from the rear side, FIG. 4A is a rear view of the wireless communication part 4, FIG. 4B is a cross sectional view of the wireless communication part 4, FIG. 5 is a vertical sectional view of the wireless communication part 4, FIG. 6A is a rear view of the wireless communication part 4 from which the second cover 43 is removed, FIG. 6B is a cross sectional view of the wireless communication part 4, and FIG. 7 is a vertical sectional view of the wireless communication part 4 from which the second cover 43 is removed. Note that, in FIGS. 4B and 6B, the lower part and the upper part in the drawings correspond to the front side and the rear side of the display unit, respectively.

The antenna 41 is formed by printing a sheet-like element on a substrate 41a such as a rigid substrate or a flexible substrate. The element of the antenna includes a ground part 41b composed of a plate-like conductor and a sheet-like radiating element 41c which is formed on the substantially same plane as the ground part 41b and connected to the ground part 41b. The ground part 41b is made of, for example, a copper foil and has the vertical and horizontal dimension of 17 mm×18 mm. The radiating element 41c is formed in a manner that a part thereof is connected to the ground part 41b and a line shaped copper foil is wound more than once. FIG. 3 illustrates an outer part of the radiating element 41c with a two-dot chain line. The vertical and horizontal dimension of the radiating element 41c is about 5 mm×18 mm. To the ground part 41b and the radiating element 41c, an external conductor and an internal conductor of a coaxial cable 41d are connected, respectively, which are further connected to a circuit (not illustrated) concerning wireless communication.

The first cover 42 is a member substantially shaped into a rectangular plate when viewed from the rear side, and includes a ground contact part 42c that comes into surface contact with the ground part 41b of the antenna 41 and a plurality of dielectric first ribs 42a that are in contact with the radiating element 41c from the front face side. The ground contact part 42c has the shape of a substantially rectangle and a dimension larger than the dimension of the ground part 41b when viewed from the rear side, and a positioning projection 42b for positioning the antenna 41 with respect to the first cover 42 is formed on its surface. The ground part 41b is, for example, in a rectangular shape and the positioning projection 42b is a line-shaped projection that is in contact with three sides of the ground part 41b other than a side to which the radiating element 41c is connected. The first ribs 42a are flat plates made of resin which protrude backward from the rear side of the first cover 42 and are arranged in a certain direction at predetermined intervals. In the present embodiment, a flat surface of each first rib 42a is substantially parallel to the short side of the display unit 1 and the plurality of first ribs 42a are arranged in parallel along the long-side direction of the display unit 1. Also, the first ribs 42a are in contact with at least the radiating element 41c of the antenna. Moreover, at a tip of the lower part of the rear side of the first rib 42a, a hook part is formed. The hook part has an L-shaped side cross section on which the lower part of the radiating element 41c of the antenna 41 is hung. The antenna 41 is positioned in the first cover 42 by the hook part and the positioning protrusion 42b.

The second cover 43, fitted with the first cover 42, is a substantially rectangular plate shaped member when viewed from the rear side, and includes a dielectric second rib 43a that is in contact with the antenna 41 from the rear side. As illustrated in FIG. 4B and FIG. 5, it is configured that the second rib 43a is provided such a position as to face the first rib 42a and the radiating element 41c of the antenna is sandwiched between the first rib 42a and the second rib 43a when the first and second covers 42, 43 are fitted with each other. The second rib 43a is, for example, L-shaped when viewed from the rear.

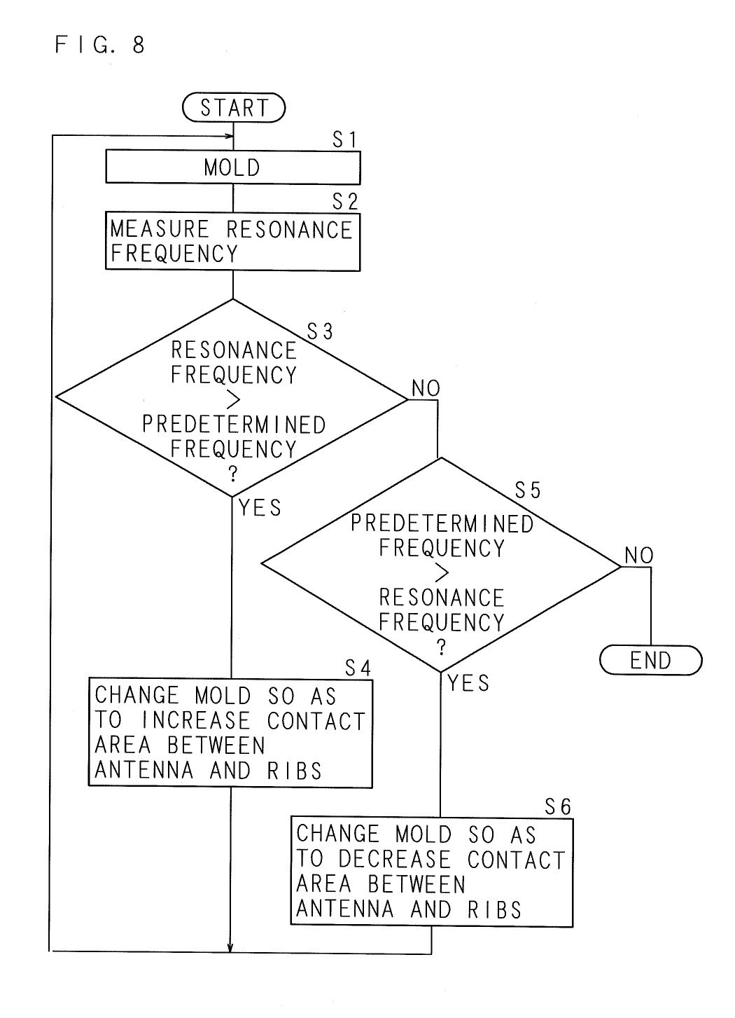

FIG. 8 is a flowchart illustrating a method for adjusting a resonance frequency. Firstly, the first and second covers 42, 43 provided with the first and second ribs 42a, 43a are molded using a mold (step S1). Then, the resonance frequency of the antenna 41 is measured in a state where the antenna 41 is sandwiched from the front and rear sides and covered by the first and second covers 42, 43 (step S2). Next, the resonance frequency is judged as to whether or not it is higher than a predetermined frequency which is defined by a standard (step S3). Needless to say, the predetermined frequency may be given a certain range. When it is judged that the resonance frequency thus measured is higher than the predetermined frequency (step S3: YES), the mold is changed so as to increase the contact area between the first and second ribs 42a, 43a and the radiating element 41c (step S4). For example, parts of the mold corresponding to flat surface parts of the first and second ribs 42a, 43a are cut so as to increase the thicknesses of the first and second ribs 42a, 43a, namely, to increase the sizes in the longitudinal direction (horizontal direction) of the display unit 1. Also, parts of the mold corresponding to end parts of the first and second ribs 42a, 43a may be cut so as to increase the height sizes of the first and second ribs 42a, 43a, namely, to increase the sizes in the front-back direction of the display unit 1. When the sizes of the ribs 42a, 43a in the front-back direction are increased, the first and second ribs 42a, 43a are in contact with the radiating element 41c more strongly, which causes increase in the substantial contact area. In this way, when the contact area between the first and second ribs 42a, 43a and the radiating element 41c is increased, the dielectric constant around the radiating element 41c is increased and the resonance frequency is decreased. When the change of the mold in step S4 is finished, step S1 and subsequent steps are again executed.

When it is judged that the resonance frequency thus measured is not higher than the predetermined frequency (step S3: NO), the resonance frequency is judged as to whether or not it is less than the predetermined frequency (step S5). When it is judged that the resonance frequency thus measured is less than the predetermined frequency (step S5: YES), the mold is changed so as to decrease the contact area between the first and second ribs 42a, 43a and the radiating element 41c (step S6). When the contact area between the first and second ribs 42a, 43a and the radiating element 41c is decreased, the dielectric constant around the radiating element 41c is decreased and the resonance frequency is increased. When the change of the mold in step S6 is finished, step S1 and subsequent steps are again executed.

In step S5, when it is judged that the resonance frequency is not less than the predetermined frequency (step S5: NO), that is, when the resonance frequency matches the predetermined frequency, or when the predetermined frequency has a range and the resonance frequency falls within the predetermined frequency band, the adjustment of the resonance frequency is finished.

According to a display apparatus and a television receiver serving as a wireless communication device configured in such a manner, it is possible to achieve reduction in size and weight of a device compared to that in the prior art and also to easily adjust the resonance frequency of a mass-produced device.

Also, because of the configuration in which the first and second ribs 42a, 43a are in contact with the sheet-like radiating element 41c, the structure of the antenna part may be made smaller and lighter compared to the structure in which the entire antenna is embedded in resin.

Moreover, the structure of the dielectric provided on the first cover 42 which is exposed to the display surface side of the display unit 1 is in a rib shape. Therefore, a sink mark is not generated on the first cover 42 thus molded, thereby not spoiling the aesthetic appearance of the cover. Also, by providing a plurality of the first ribs 42a, it is possible to secure a wide adjustment range of a resonance frequency without spoiling the aesthetic appearance of the first cover 42.

Moreover, according to the present embodiment, the resonance frequency of the antenna is adjusted by changing the molds of the first and second covers 42, 43 on which the first and second ribs 42a, 43a are provided. Therefore, it is possible to mass-produce a wireless communication device, the display unit 1 and the television receiver in which a resonance frequency has been adjusted. That is, no operation is required for adjusting the resonance frequency of each device which is mass-produced.

In the embodiment, a television receiver is described as a specific example of a display apparatus. The present invention may, however, be applied to a portable terminal such as a notebook computer, a PDA, a portable telephone or an image pickup apparatus. Also, if it is a device having a wireless communication function, the present invention may be applied to a wireless communication device such as an acoustic device, a printer, an image pickup apparatus which do not have the display unit 1.

(Modification 1)

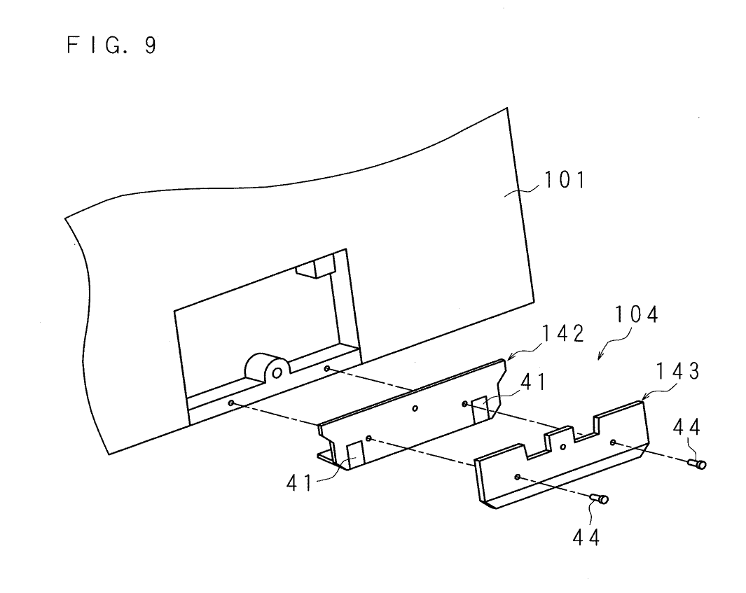

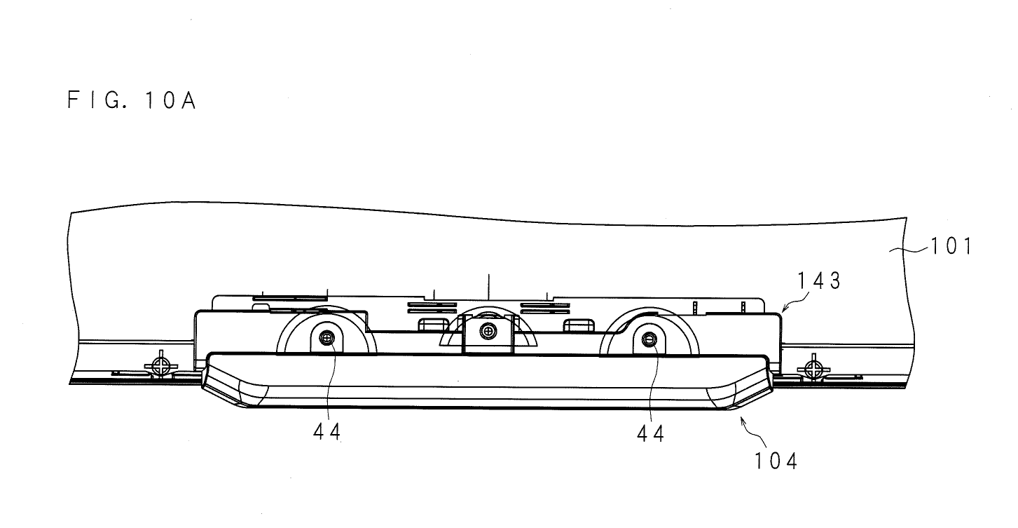

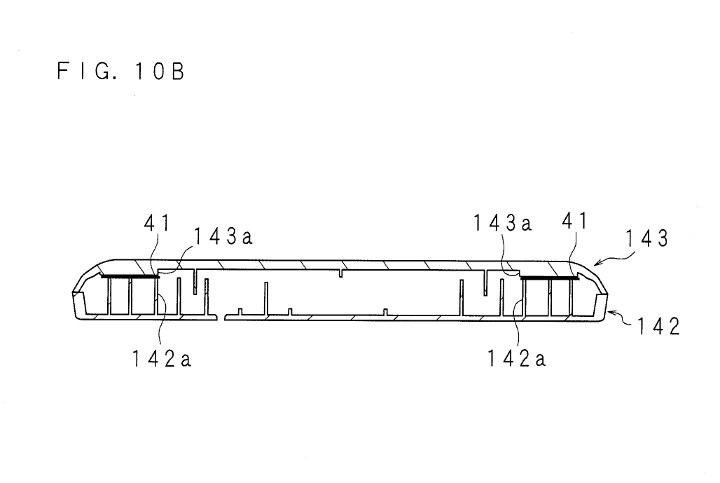

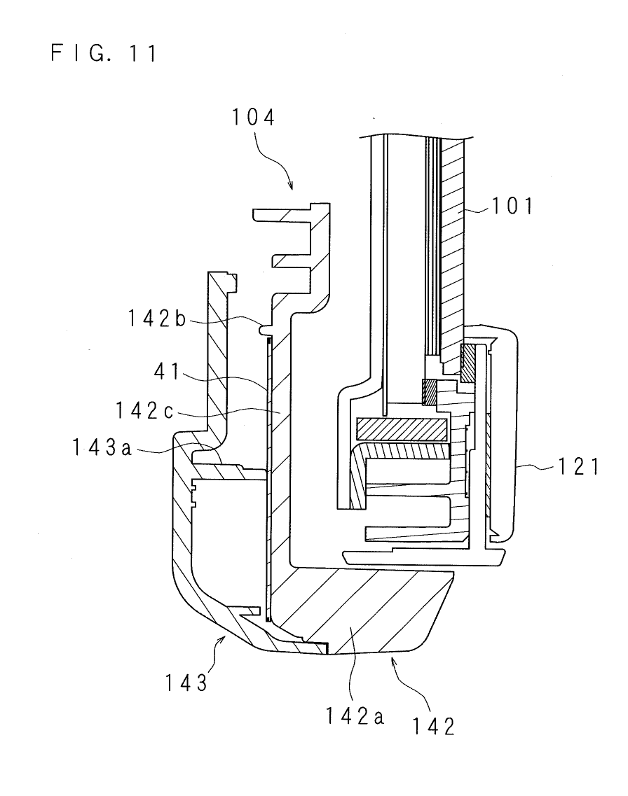

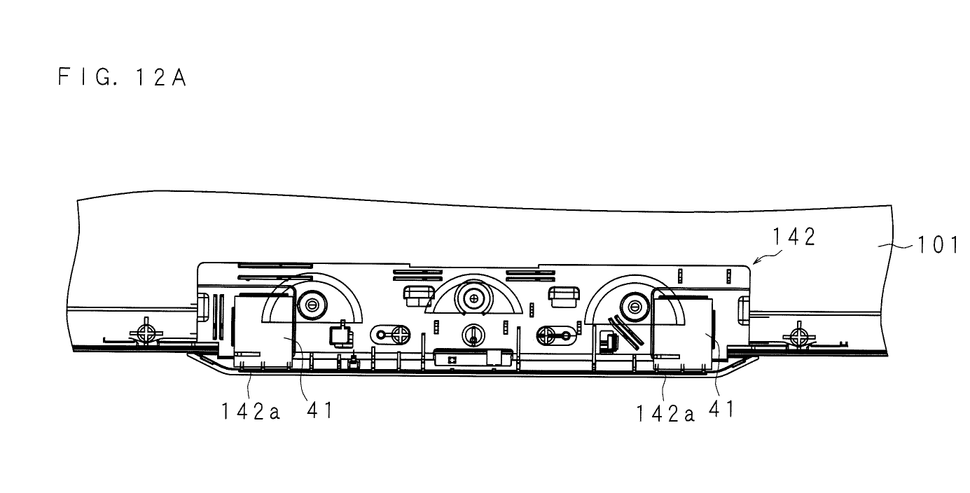

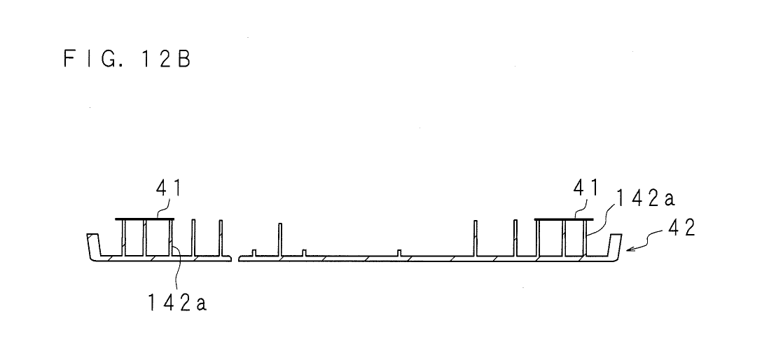

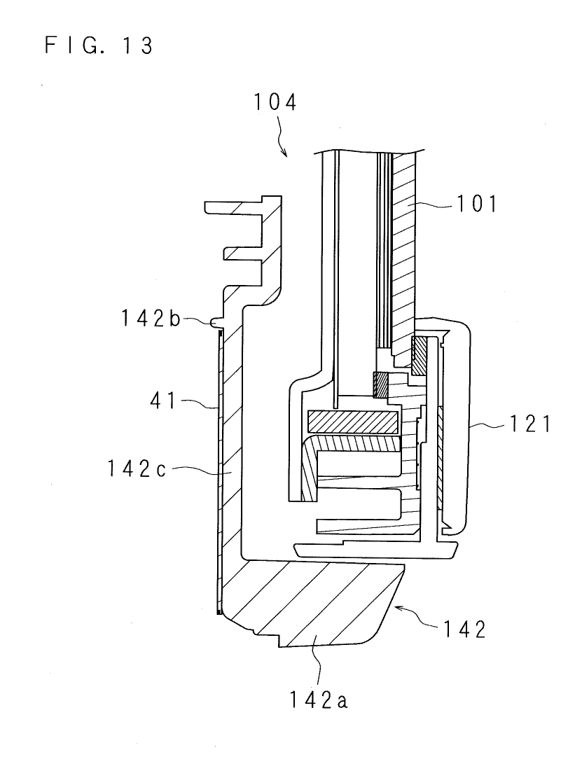

FIG. 9 is an exploded perspective view of a main part of a wireless communication part 104 included in a display apparatus according to Modification 1, FIG. 10A is a rear view of the wireless communication part 4 according to Modification 1, FIG. 10B is a cross sectional view of the wireless communication part 104 according to Modification 1, FIG. 11 is a vertical sectional view of the wireless communication part 104 according to Modification 1, FIG. 12A is a rear view of the wireless communication part 104 according to Modification 1 from which the second cover 143 is removed, FIG. 12B is a cross sectional view of the wireless communication part 104 according to Modification 1 from which the second cover 143 is removed, FIG. 13 is a vertical sectional view of the wireless communication part 104 according to Modification 1 from which the second cover 143 is removed.

The basic structure of a display apparatus according to Modification 1 is similar to that of the embodiment. It is an example where the present invention is applied to a smaller display apparatus, such as a 32-inch television receiver or a 40-inch television receiver. The display apparatus according to Modification 1 includes a display unit 101, a cabinet, a wireless communication part 104, a stand and a tuner, as similar to the embodiments. Here, as an example, a case is described in which the tuner is built in. Needless to say, it is also possible to have such a configuration that the tuner is separated from the display apparatus (separated type) and an image signal is transmitted via wireless communication.

The wireless communication part 104 includes an antenna 41 as well as the first and second covers 142, 143. On the rear side of the first cover 142, three first ribs 142a are provided which are in contact with a radiating element print-formed in each antenna 41. On the front side of the second cover 143, a second rib 143a that is in contact with a radiating element print-formed in each antenna 41 from the rear side. The second rib 143a is, for example, substantially T-shaped when viewed from the rear. The structures of a positioning protrusion 142b, a ground contact part 142c, a hook part formed on the first rib 142a are the same as the corresponding parts in the embodiment.

According to a display apparatus and a television receiver as a wireless communication device in modification 1, as similar to the embodiments, it is possible to obtain an effect of achieving reduction in size and weight of a device compared to that in the prior art and easily adjusting the resonance frequency of a mass-produced device.

(Modification 2)

As a display apparatus according to Modification 2 is only different in the structure of a wireless communication part, specifically, the structure of the first cover, the above-mentioned difference is mainly described hereinafter.

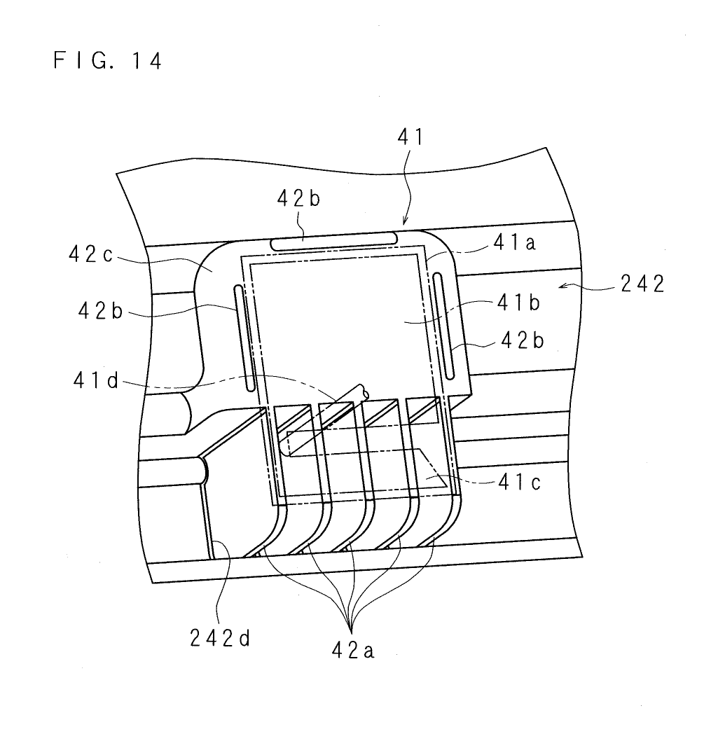

FIG. 14 is an exploded perspective view of a main part of a wireless communication part according to Modification 2 when viewed from the rear. As described in the embodiment, a first cover 242 is a substantially rectangular plate shaped member when viewed from the rear, and includes a ground contact part 42c and a plurality of dielectric first ribs 42a. At a connecting part between each first rib 42a and the first cover 242, namely, at the root of the first rib 42a, a groove 242d for snapping off the first rib 42a is formed.

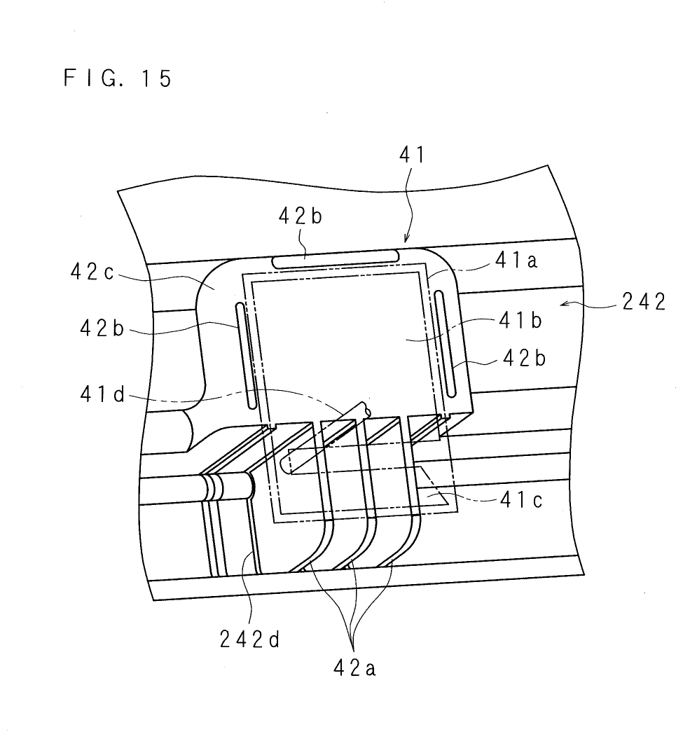

FIG. 15 is an exploded perspective view of a main part of the wireless communication part in which the number of the first ribs is reduced by snapping off some of the first ribs. The first cover 242 according to modification 2 has groove parts 242d for snapping off the first ribs 42a. Therefore, when pushing and bending the first rib 42a over sideways, the first rib 42a is broken at the groove part 242d so that the first rib 42a can be removed as illustrated in FIG. 15. By removing the first rib 42a, it is possible to decrease the contact area between the antenna 41 and a plurality of the first ribs 42a and increase a resonance frequency of the antenna 41.

According to a display apparatus and a television receiver serving as a wireless communication device in Modification 2, it is possible to adjust the resonance frequency of the antenna 41 easily by reducing the number of the first ribs 42a by a mechanical processing. Even in a case where the resonance frequency of the antenna 41 is different in each product or each model of the display apparatus, it is possible to promptly adjust the resonance frequency of the antenna 41 by performing a mechanical processing on the first cover 242 without changing a mold. Also, even when the resonance frequency is changed by a change in types or the like of the antenna 41, it is possible to promptly adjust the resonance frequency of the antenna 41 by performing a mechanical processing on the first cover 242 without changing a mold. Moreover, even in a case where the resonance frequency of the antenna 41 covered with the mass-produced first cover 242 and the second cover 43 does not fall within a range of a predetermined frequency although the shape of the mold has been modified, it is possible to promptly adjust the resonance frequency of the antenna 41 by performing a mechanical processing of the first cover 242.

(Modification 3)

As a display apparatus according to Modification 3 is only different in the structure of a wireless communication part, specifically, the structure of the first rib, the above-mentioned difference is mainly described hereinafter.

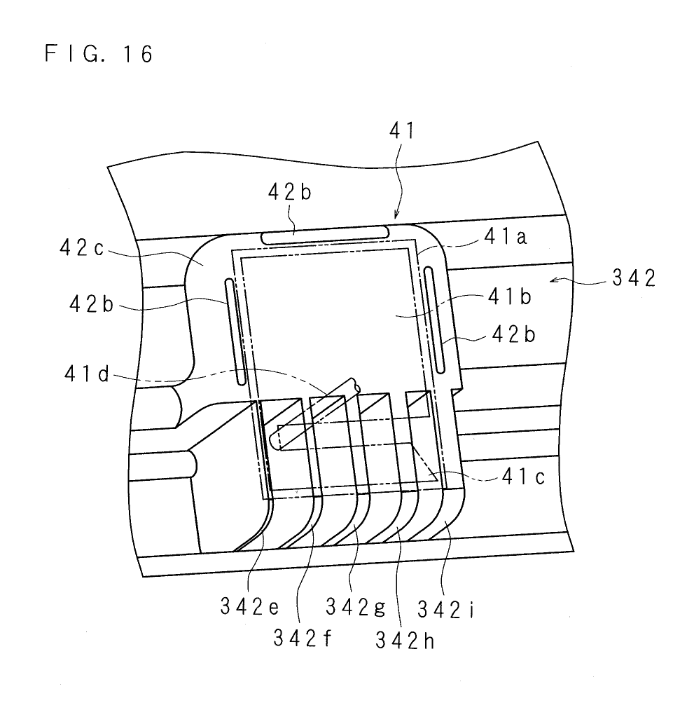

FIG. 16 is an exploded perspective view of a wireless communication part according to Modification 3 from which the second cover is removed. As described in the embodiment, a first cover 342 is a substantially rectangular plate shaped member when viewed from the rear, and includes a ground contact part 42c and a plurality of dielectric first ribs 342e, 342f, 342g, 342h and 342i. The plurality of first ribs 342e, 342f, 342g, 342h, 342i according to Modification 3 are different from each other in thickness. Specifically, the thicknesses of the first ribs 342f, 342g, 342h, 342i are two times, three times, four times, five times larger than the thickness of the first rib 342e, respectively. A groove may be provided at the root of each of the first ribs 342e, 342f, 342g, 342h, 342i in Modification 3, as in Modification 2.

According to a display apparatus and a television receiver serving as a wireless communication device in Modification 3, it is possible to adjust the resonance frequency efficiently by snapping off appropriate at least one of the first ribs 342e, 342f, 342g, 342h, 342i in accordance with a required correction of the resonance frequency.

For example, when the resonance frequency of the antenna 41 is much smaller than a predetermined frequency, it is possible to greatly increase the resonance frequency by snapping off the thick first rib 342i so as to adjust the resonance frequency. When the resonance frequency of the antenna 41 is slightly smaller than a predetermined frequency, it is possible to slightly increase the resonance frequency by snapping off the thin first rib 342e so as to make a fine adjustment of the resonance frequency. Accordingly, the number of processes on the first ribs 342e, 342f, 342g, 342h, 342i which is necessary for adjusting a resonance frequency can be reduced.

As described in Modification 3, it is possible to correct the resonance frequency efficiently. Also, by selecting a rib to be snapped off among the first ribs 342e, 342f, 342g, 342h, 342i, it is possible to make a coarse adjustment and a fine adjustment of a resonance frequency.

(Modification 4)

As a display apparatus according to Modification 4 is only different in the structure of a wireless communication part, specifically, the structure of the first rib, the above-mentioned difference is mainly described hereinafter.

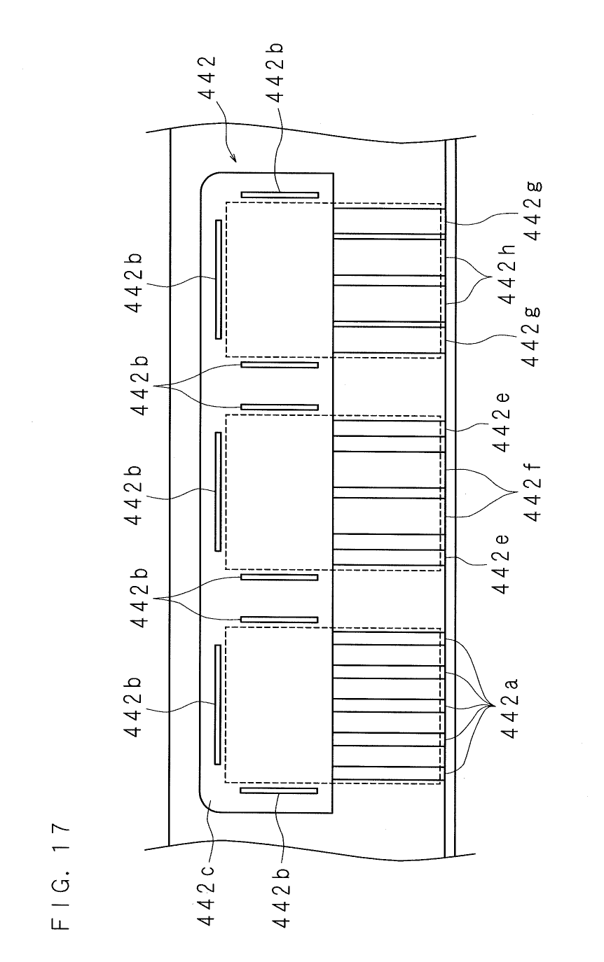

FIG. 17 is a vertical sectional view of a wireless communication part according to Modification 4 from which the second cover is removed. A first cover 442 is a substantially rectangular plate shaped member when viewed from the rear, and includes a ground contact part 442c that comes into surface contact with a ground part 41b of an antenna 41 and a plurality of dielectric first ribs 442a, 442e, 442f, 442g and 442h that are in contact with a radiating element 41c from the front face side. The ground contact part 442c according to Modification 4 has a dimension larger than the dimension of the ground part 41b of the antenna 41 when viewed from the rear and a substantially rectangular shape having a width in which the antenna 41 can be arranged in a plurality of different portions. Also, when the antenna 41 is arranged on each of the different portions, a positioning protrusion 442b for positioning the antenna 41 with respect to the first cover 442 is formed on a surface of the ground contact part 442c for each of the portions. The detailed structure of the positioning protrusion 442b is similar to that of the embodiment.

Hereinafter, a portion enclosed by a quadrangle with broken line is the portion in which the antenna 41 can be arranged in FIG. 17. The right portion where the antenna 41 can be arranged is referred to as the first portion, a portion in the center is referred to as the second portion, and a left portion is referred to as the third portion.

In the first portion, the first rib 442a is provided as similar to the embodiment.

In the second portion, the first ribs 442e, 442f are provided. It is configured that the first rib 442f provided in the central portion is thicker than the first rib 442e provided on the both sides, and that the total area in which the first ribs 442e, 442f are in contact with the ground part 41b of the antenna 41 in the second portion is greater than the total area in which the first ribs 442a are in contact with the ground part 41b of the antenna 41 in the first portion.

In the third portion, the first ribs 442g, 442h are provided. It is configured that the first rib 442h provided in the central portion is thicker than the first rib 442g provided on the both sides, and that the total area in which the first ribs 442g, 442h are in contact with the ground part 41b of the antenna 41 in the third portion is greater than the total area in which the first ribs 442e, 442f are in contact with the ground part 41b of the antenna 41 in the second portion.

According to a display apparatus and a television receiver serving as a wireless communication device according to Modification 4, it is possible to adjust the resonance frequency easily by changing the arrangement of the antenna 41. Even in a case where the resonance frequency of the antenna 41 is different in each product or each model of the display apparatus, it is possible to promptly adjust the resonance frequency of the antenna 41 by merely changing the arrangement of the antenna 41 with respect to the first cover 442 without changing a mold. Also, even when the resonance frequency is changed by, for example, a change in the type of the antenna 41, it is possible to promptly adjust the resonance frequency by changing the arrangement of the antenna 41 with respect to the first cover 442 without changing a mold. Moreover, even in a case where the resonance frequency of the antenna 41 covered with the mass-produced first cover 442 and the second cover 43 does not fall within a range of a predetermined frequency although the shape of the mold has been modified, it is possible to promptly adjust the resonance frequency of the antenna 41 by changing the arrangement of the antenna 41 with respect to the first cover 442.

(Modification 5)

As a display apparatus according to Modification 5 is only different in the structure of a wireless communication part, specifically, the structure of the first rib, the above-mentioned difference is mainly described hereinafter.

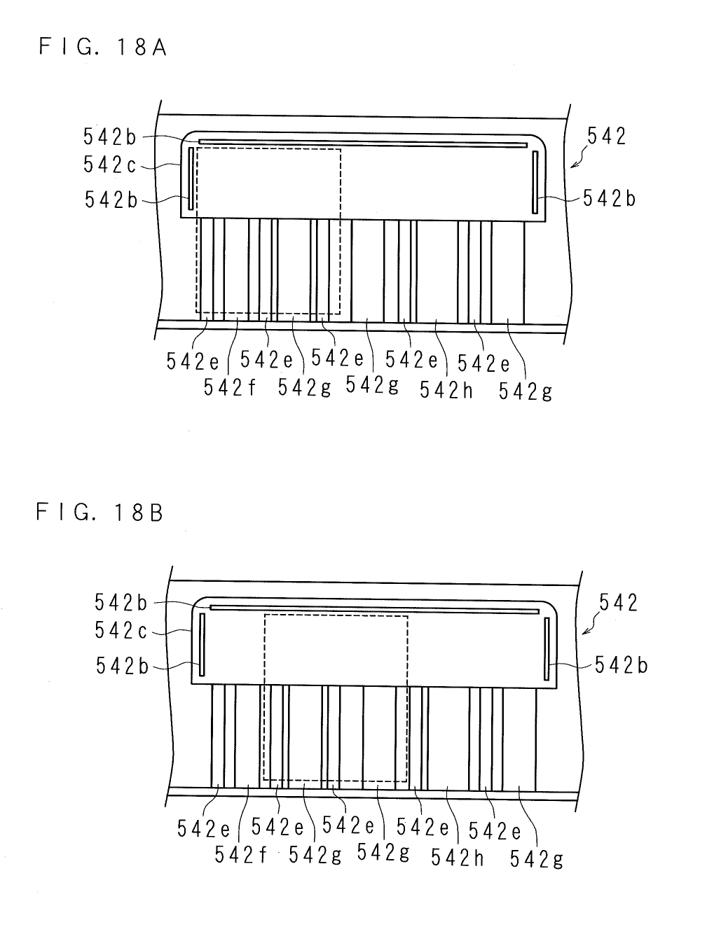

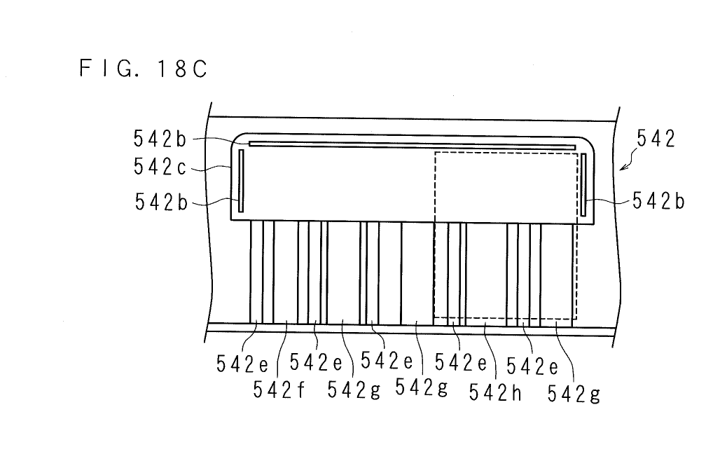

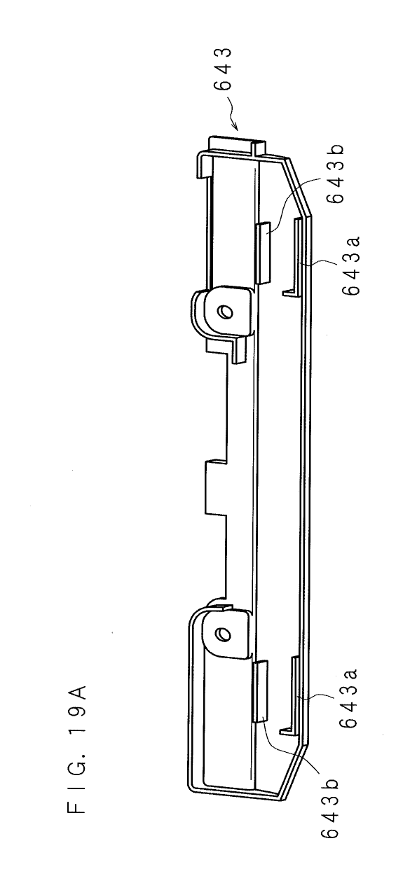

FIGS. 18A to 18C are vertical sectional views of a wireless communication part according to Modification 5 from which the second cover is removed. A first cover 542 is a substantially rectangular plate shaped member when viewed from the rear, and includes a ground contact part 542c that comes into surface contact with a ground part 41b of an antenna 41 and a plurality of dielectric first ribs 542e, 542f, 542g, 542h that are in contact with a radiating element 41c from the front face side. The ground part 542c according to Modification 5 has a dimension larger than the dimension of the ground part 41b of the antenna 41 when viewed from the rear and has a substantially rectangular shape having a width in which the arrangement of the antenna 41 may be appropriately shifted, as shown in FIGS. 18A to C. The first ribs 542e, 542f, 542g and 542h have different thicknesses from each other and are arranged in parallel with each other in an area wider than the area in which the antenna 41 is in contact with the first ribs 542e, 542f. The illustrated thicknesses and arrangement of the first ribs 542e, 542f, 542g, 542h are a mere example. As long as the total area in which the ground part 41b of the antenna 41 is in contact with the first ribs 542e, 542f, 542g, 542h is changed based on the arrangement of the antenna 41, many variations are available.

Also, a positioning protrusion 542b is formed on a surface of the ground contact part 542c, which positions the antenna 41 with respect to the first cover 542 when the antenna 41 is arranged. The positioning protrusion 542b includes, for example, a line-shaped protrusion that is in contact with the right end of the ground part 41b when the antenna 41 is located at the right end, a line-shaped protrusion that is in contact with the left end of the ground part 41b when the antenna 41 is located at the left end, and a line-shaped protrusion that is in contact with the upper end of the antenna 41.

According to a display apparatus and a television receiver serving as an wireless communication device according to Modification 5, as illustrated in FIGS. 18A to C, it is possible to adjust the resonance frequency of the antenna 41 easily by only changing the arrangement of the antenna 41, as similar to modification 4.

(Modification 6)

As a display apparatus according to Modification 6 is only different in the structure of a wireless communication part, specifically, the structure of the second cover, and configured to adjust a resonance frequency of an antenna by changing the second cover, the above-mentioned difference is mainly described hereinafter.

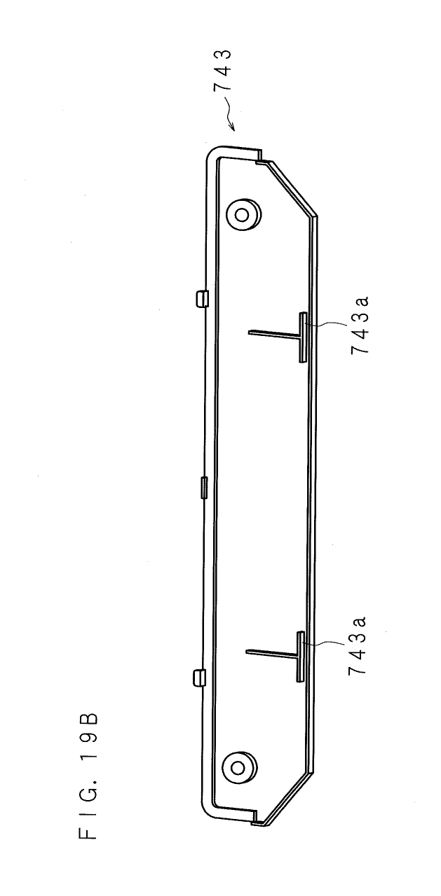

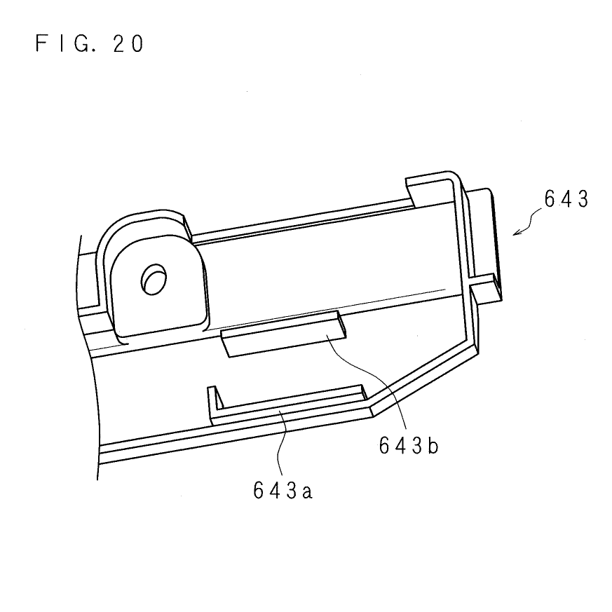

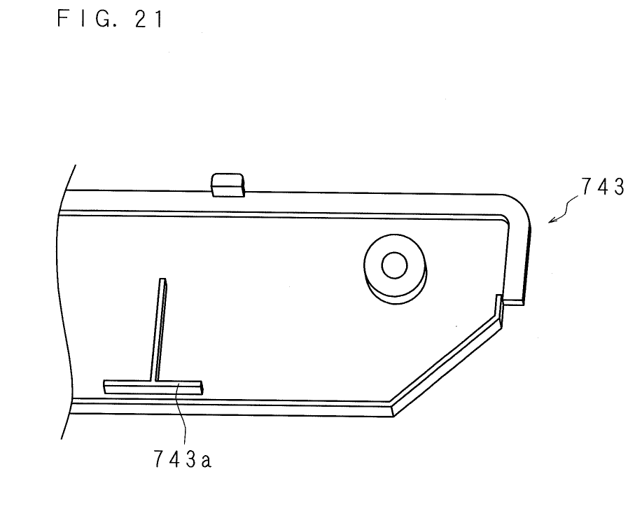

FIGS. 19A and 19B are perspective views illustrating a plurality of different second covers according to Modification 6, FIG. 20 is a perspective view illustrating a main part of the second cover having the second rib of a L-shape, and FIG. 21 is a perspective view illustrating a main part of the second cover having the second rib of a T-shape. As illustrated in FIGS. 19A and 20, a second cover 643 of a wireless communication part includes an L-shaped second rib 643a and a linear second rib 643b which are in contact with a ground part 41b of an antenna 41. The second over 743 includes an inverted T-shaped second rib 743a as illustrated in FIGS. 19B and 21. It is configured such that the total area in which the second ribs 643a, 643b of the second cover 643 are in contact with the ground part 41b of the antenna 41 is different from the total area in which the second ribs 743a of the second cover 743 is in contact with the ground part 41b.

With a display apparatus and a television receiver serving as a wireless communication device according to Modification 6, it is possible to easily adjust the resonance frequency of the antenna 41 by preparing a plurality of second covers 643, 743 having different contact areas for the second ribs 643a, 643b, 743a with respect to the ground part 41b, and by appropriately switching the second covers 643, 743 to be used. Even in a case where the resonance frequency of the antenna 14 is different in each product or each model of the display apparatus, it is possible to promptly adjust the resonance frequency of the antenna 41 by switching the second covers 643, 743 without changing a mold. Also, even when the resonance frequency is changed by, for example, a change in the type of the antenna 41, it is possible to promptly adjust the resonance frequency of the antenna 41 by switching the second covers 643, 743 without changing a mold. Moreover, even in a case where the resonance frequency of the antenna 41 covered with the mass-produced first cover 42 and second covers 643, 743 does not fall within a range of a predetermined frequency although the shape of the mold has been modified, it is possible to promptly adjust the resonance frequency of the antenna 41 by switching the second covers 643, 743.

It should be understood that the embodiments described above are only illustrative but not limitative. The scope of the present invention is defined in the claims and includes all changes that fall within metes and bounds of the claims or equivalence of such metes and bounds thereof, but not limited to the above description.

1.-13. (canceled)

14. A wireless communication device, comprising:
a sheet-like antenna; and
a cover for covering the antenna,
wherein
a plurality of dielectric ribs that are in contact with the antenna is provided on the antenna side of the cover,
at least one of the plurality of ribs has a different thickness, and
the plurality of ribs are provided side by side with one another in an area wider than an area in which the antenna is in contact with the ribs.

15. The wireless communication device according to claim 14,
wherein
at least one of the plurality of ribs has a different thickness.

16. The wireless communication device according to claim 14, wherein
the plurality of ribs are provided on a plurality of portions of the cover on which the antenna can be arranged, and the plurality of ribs provided in each portion are configured such that, when the antenna is provided in each of the portions, a total area in which the plurality of ribs are in contact with the antenna is different for each portion.

17. The wireless communication device according to claim 14, wherein
the antenna includes:
a ground part; and
a sheet-like radiating element connected to the ground part, and
the rib is in contact with at least the radiating element.

18. The wireless communication device according to claim 17, wherein
the ground part and the radiating element are print-formed on a rigid substrate or a flexible substrate.

19. The wireless communication device according to claim 14, wherein
the cover includes:
a first cover for covering one surface side of the antenna; and
a second cover for covering another surface side of the antenna,
and wherein
the ribs are provided on the first cover and the second cover, respectively, the rib provided on the first cover coming into contact with one surface side of the antenna and the rib provided on the second cover coming into contact with another surface side of the antenna.

20. The wireless communication device according to claim 14, comprising a display unit, wherein
the antenna is provided on a periphery of the display unit.

21. A wireless communication device, comprising:
a sheet-like antenna; and
a cover for covering the antenna,
wherein
a dielectric rib that is in contact with the antenna is provided on the antenna side of the cover, and
a groove is formed at a connecting part between the rib and the cover.

22. The wireless communication device according to claim 21,
wherein
a plurality of the ribs are provided on the cover.

23. The wireless communication device according to claim 22,
wherein
at least one of the plurality of ribs has a different thickness.

24. The wireless communication device according to claim 22, wherein
the plurality of ribs are provided on a plurality of portions of the cover on which the antenna can be arranged, and the plurality of ribs provided in each portion are configured such that, when the antenna is provided in each of the portions, a total area in which the plurality of ribs are in contact with the antenna is different for each portion.

25. The wireless communication device according to claim 21, wherein
the antenna includes:
a ground part; and
a sheet-like radiating element connected to the ground part, and
the rib is in contact with at least the radiating element.

26. The wireless communication device according to claim 25, wherein
the ground part and the radiating element are print-formed on a rigid substrate or a flexible substrate.

27. The wireless communication device according to claim 21, wherein
the cover includes:
a first cover for covering one surface side of the antenna; and
a second cover for covering another surface side of the antenna,
and wherein
the ribs are provided on the first cover and the second cover, respectively, the rib provided on the first cover coming into contact with one surface side of the antenna and the rib provided on the second cover coming into contact with another surface side of the antenna.

28. The wireless communication device according to claim 21, comprising a display unit, wherein
the antenna is provided on a periphery of the display unit.

29. A display apparatus comprising:
a display unit;
a sheet-like antenna provided on a periphery of the display unit; and
a cover for covering the antenna,
wherein
a plurality of dielectric ribs that are in contact with the antenna is provided on the antenna side of the cover,
at least one of the plurality of ribs has a different thickness, and
the plurality of ribs are provided side by side with one another in an area wider than an area in which the antenna is in contact with the ribs.

30. A display apparatus comprising:
a display unit;
a sheet-like antenna provided on a periphery of the display unit; and
a cover for covering the antenna,
wherein
a dielectric rib that is in contact with the antenna is provided on the antenna side of the cover, and
a groove is formed at a connecting part between the rib and the cover.

31. A television receiver, comprising:
a receiving part for receiving a television signal;
a display unit for displaying an image with a television signal received by the receiving part;
a sheet-like antenna provided on a periphery of the display unit; and
a cover for covering the antenna,
wherein
a plurality of dielectric ribs that are in contact with the antenna is provided on the antenna side of the cover,
at least one of the plurality of ribs has a different thickness, and
the plurality of ribs are provided side by side with one another in an area wider than an area in which the antenna is in contact with the ribs.

32. A television receiver, comprising:
a receiving part for receiving a television signal;
a display unit for displaying an image with a television signal received by the receiving part;
a sheet-like antenna provided on a periphery of the display unit; and
a cover for covering the antenna,
wherein
a dielectric rib that is in contact with the antenna is provided on the antenna side of the cover, and
a groove is formed at a connecting part between the rib and the cover.

33. A method for adjusting a resonance frequency of the antenna included in the wireless communication device according to claim 14, comprising:
molding, using a mold, a cover on which the rib is provided;
measuring a resonance frequency of the antenna covered with the molded cover;
comparing the measured resonance frequency with a predetermined frequency; and
changing the mold so that a contact area between the rib and the antenna is increased when the measured resonance frequency is higher than the predetermined frequency, and that a contact area between the rib and the antenna is decreased when the measured resonance frequency is lower than the predetermined frequency.

34. A method for adjusting a resonance frequency of the antenna included in the wireless communication device according to claim 21, comprising:
molding, using a mold, a cover on which the rib is provided;
measuring a resonance frequency of the antenna covered with the molded cover;
comparing the measured resonance frequency with a predetermined frequency; and
changing the mold so that a contact area between the rib and the antenna is increased when the measured resonance frequency is higher than the predetermined frequency, and that a contact area between the rib and the antenna is decreased when the measured resonance frequency is lower than the predetermined frequency.

35. A method for adjusting a resonance frequency of the antenna included in the display apparatus according to claim 29, comprising:
molding, using a mold, a cover on which the rib is provided;
measuring a resonance frequency of the antenna covered with the molded cover;
comparing the measured resonance frequency with a predetermined frequency; and
changing the mold so that a contact area between the rib and the antenna is increased when the measured resonance frequency is higher than the predetermined frequency, and that a contact area between the rib and the antenna is decreased when the measured resonance frequency is lower than the predetermined frequency.

36. A method for adjusting a resonance frequency of the antenna included in the display apparatus according to claim 30, comprising:
molding, using a mold, a cover on which the rib is provided;
measuring a resonance frequency of the antenna covered with the molded cover;
comparing the measured resonance frequency with a predetermined frequency; and
changing the mold so that a contact area between the rib and the antenna is increased when the measured resonance frequency is higher than the predetermined frequency, and that a contact area between the rib and the antenna is decreased when the measured resonance frequency is lower than the predetermined frequency.

37. A method for adjusting a resonance frequency of the antenna included in the television receiver according to claim 31, comprising:
molding, using a mold, a cover on which the rib is provided;
measuring a resonance frequency of the antenna covered with the molded cover;
comparing the measured resonance frequency with a predetermined frequency; and
changing the mold so that a contact area between the rib and the antenna is increased when the measured resonance frequency is higher than the predetermined frequency, and that a contact area between the rib and the antenna is decreased when the measured resonance frequency is lower than the predetermined frequency.

38. A method for adjusting a resonance frequency of the antenna included in the television receiver according to claim 32, comprising:
molding, using a mold, a cover on which the rib is provided;
measuring a resonance frequency of the antenna covered with the molded cover;
comparing the measured resonance frequency with a predetermined frequency; and
changing the mold so that a contact area between the rib and the antenna is increased when the measured resonance frequency is higher than the predetermined frequency, and that a contact area between the rib and the antenna is decreased when the measured resonance frequency is lower than the predetermined frequency.
